(19) United States
(12) Patent Application Publication
(10) Pub. No.: US 2014/0297479 A1
(43) Pub. Date: Oct. 2, 2014

(54) ELECTRONIC SYSTEM WITH REAL PROPERTY PREFERENCE MECHANISM AND METHOD OF OPERATION THEREOF

(71) Applicant: HouseHappy, Inc., Portland, OR (US)

(72) Inventors: Kevin McCloskey, Portland, OR (US); Servando R. Salazar, Portland, OR (US)

(73) Assignee: HouseHappy, Inc., Portland, OR (US)

(21) Appl. No.: 14/226,611

(22) Filed: Mar. 26, 2014

Related U.S. Application Data
(60) Provisional application No. 61/805,146, filed on Mar. 26, 2013.

(51) Int. Cl. G06Q 30/06; G06Q 50/16

(52) U.S. Cl. CPC G06Q 30/0627; G06Q 50/16
USPC 705/26.63

(57) ABSTRACT

An electronic system includes: a control unit configured to identify a first indication input associated with a first real property post; generate a preference maximization profile of a second real property post based on the first indication input; generate a proposed property content based on the first indication input, the preference maximization profile, the second real property post, or a combination thereof for procuring a second indication input associated with the second real property post; and a display unit, coupled to the control unit, configured to display the proposed property content.

### CROSS-REFERENCE TO RELATED APPLICATION

This application claims the benefit of U.S. Provisional Patent Application Ser. No. 61/805,146 filed Mar. 26, 2013, and the subject matter thereof is incorporated herein by reference thereto.

### TECHNICAL FIELD

The present invention relates generally to an electronic system, and more particularly to a system with a real property preference mechanism.

### BACKGROUND

Modern portable consumer and industrial electronics, especially client devices such as computing systems, electronic systems, mobile phones, tablet computers, and combination devices, are providing increasing levels of functionality to support modern life including real property search and recommendation services. Research and development in the existing technologies can take myriad directions.

However, the consumer's preference for ever smaller device form factors has decreased the display interface of such devices. This represents challenges of accessing more information and content on a smaller device.

Thus, a need still remains for an electronic system with a real property preference mechanism appropriate for today's devices. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides an electronic system, including: a control unit, configured to identify a first preference input associated with a first real property post; generate a preference maximization profile of a second real property post based on the first indication input; generate a proposed property content based on the first indication input, the preference maximization profile, the second real property post , or a combination thereof for procuring a second indication input associated with the second real property post; and a display unit, coupled to the control unit, configured to display the proposed property content.

An embodiment of the present invention provides a method of operation of an electronic system including: identifying, with a control unit, a first indication input associated with a first real property post; generating a preference maximization profile of a second real property post based on the first indication input; generating a proposed property content based on the first indication input, the preference maximization profile, the second real property post, or a combination thereof for procuring a second indication input associated with the second real property post; and displaying the proposed property content.

An embodiment of the present invention provides a non-transitory computer readable medium including: identifying a first indication input associated with a first real property post; generating a preference maximization profile of a second real property post based on the first indication input; generating a proposed property content based on the first indication input, the preference maximization profile, the second real property post, or a combination thereof for procuring a second indication input associated with the second real property post; and displaying the proposed property content.

Certain embodiments of the invention have other steps or elements in addition to or in place of those mentioned above. The steps or element will become apparent to those skilled in the art from a reading of the following detailed description when taken with reference to the accompanying drawings.

### BRIEF DESCRIPTION OF THE DRAWINGS

FIG. 1 is an electronic system with a real property preference mechanism in an embodiment of the present invention.

FIG. 2 is an example of a display interface of the first device.

FIG. 3 is another example of a display interface of the first device.

FIG. 4 is another example of a display interface of the first device.

FIG. 5 is another example of a display interface of the first device.

FIG. 6 is another example of a display interface of the first device.

FIG. 7 is an exemplary block diagram of the electronic system.

FIG. 8 is a control flow of the electronic system.

FIG. 9 is a flow chart of a method of operation of the electronic system in a further embodiment of the present invention.

### DETAILED DESCRIPTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation.

The term “relevant information” referred to herein includes the navigation information described as well as information relating to points of interest to the user, such as local business, hours of businesses, types of businesses, advertised specials, traffic information, maps, local events, and nearby community or personal information.

The term “module” referred to herein can include software, hardware, or a combination thereof in the embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

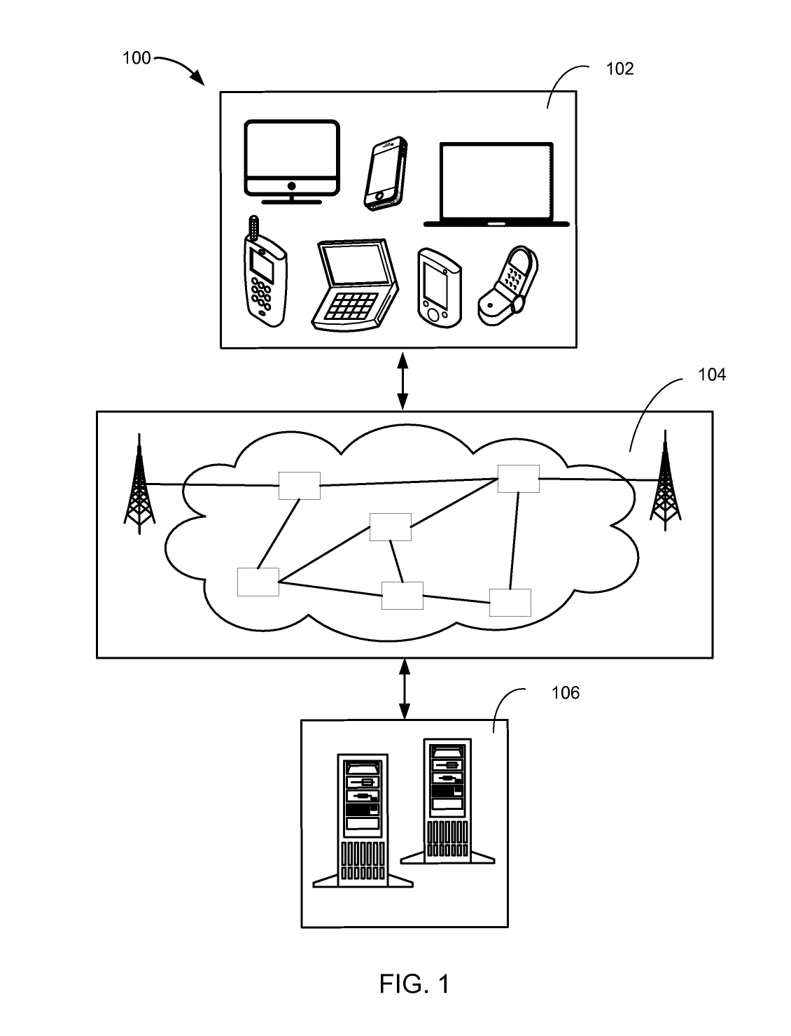

Referring now to FIG. 1, therein is shown an electronic system 100 with a real property preference mechanism in an embodiment of the present invention. The electronic system 100 includes a first device 102, such as a client or a server, connected to a second device 106, such as a client or server, with a communication path 104, such as a wireless or wired network.

For example, the first device 102 can be of any of a variety of mobile devices, such as a cellular phone, tablet device, a smartphone, a wearable device, a personal digital assistant, a notebook computer, automotive telematic navigation system, or other multi-functional mobile communication or entertainment device. The first device 102 can couple to the communication path 104 to communicate with the second device 106.

For illustrative purposes, the electronic system 100 is described with the first device 102 as a computing device, although it is understood that the first device 102 can be different types of computing devices. For example, the first device 102 can also be a server, a server farm, or a desktop computer.

The second device 106 can be any of a variety of centralized or decentralized computing devices. For example, the second device 106 can be a computer, grid computing resources, a virtualized computer resource, cloud computing resource, routers, switches, peer-to-peer distributed computing devices, or a combination thereof

The second device 106 can be centralized in a single computer room, distributed across different rooms, distributed across different geographical locations, embedded within a telecommunications network. The second device 106 can have a means for coupling with the communication path 104 to communicate with the first device 102. The second device 106 can also be a client type device as described for the first device 102.

In another example, the first device 102 can be a particularized machine, such as a mainframe, a server, a cluster server, a rack mounted server, or a blade server, or as more specific examples, an IBM System z10™ Business Class mainframe or a HP ProLiant ML™ server. Yet another example, the second device 106 can be a particularized machine, such as a portable computing device, a thin client, a notebook, a netbook, a smartphone, personal digital assistant, or a cellular phone, and as specific examples, an Apple iPhone™, a Samsung Galaxy™, a Microsoft Windows Phone™, an HTC One™, or a Motorola Moto™.

For illustrative purposes, the electronic system 100 is described with the second device 106 as a non-mobile computing device, although it is understood that the second device 106 can be different types of computing devices. For example, the second device 106 can also be a mobile computing device, such as a notebook computer, another client device, or a different type of client device. The second device 106 can be a standalone device, or can be incorporated with a vehicle, for example a car, truck, bus, or train.

Also for illustrative purposes, the electronic system 100 is shown with the second device 106 and the first device 102 as end points of the communication path 104, although it is understood that the electronic system 100 can have a different partition between the first device 102, the second device 106, and the communication path 104. For example, the first device 102, the second device 106, or a combination thereof can also function as part of the communication path 104.

The communication path 104 can be a variety of networks. For example, the communication path 104 can include wireless communication, wired communication, optical, ultrasonic, or a combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104.

Further, the communication path 104 can traverse a number of network topologies and distances. For example, the communication path 104 can include direct connection, personal area network (PAN), local area network (LAN), metropolitan area network (MAN), wide area network (WAN) or any combination thereof

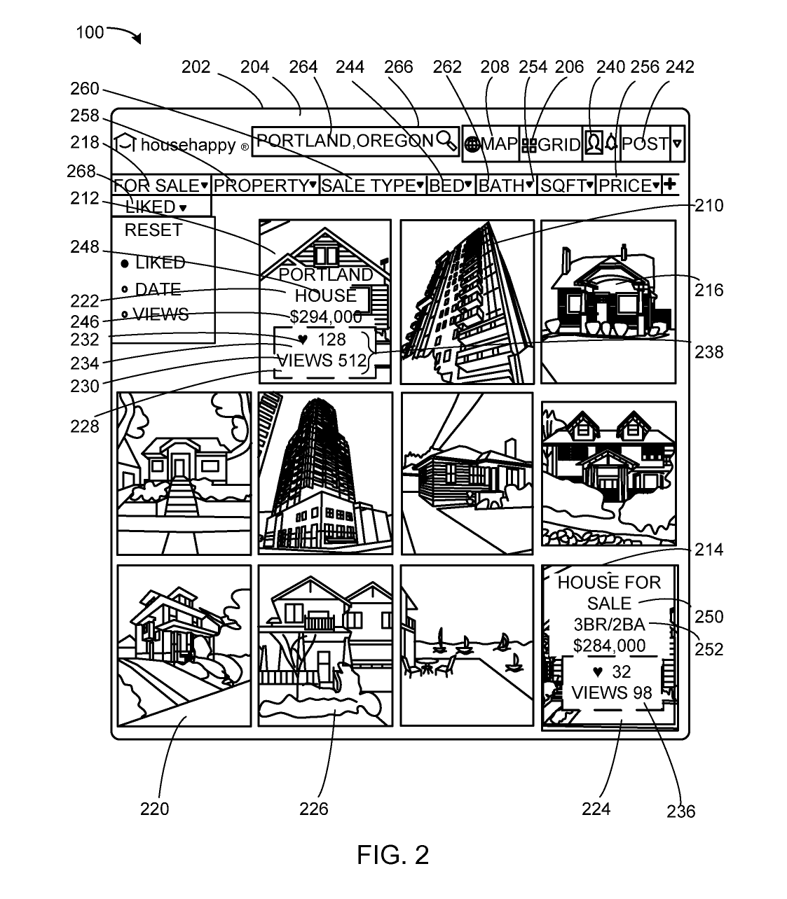

Referring now to FIG. 2 therein is shown an example of a display interface 202 of the first device 102. The display interface 202 can depict a presentation graphic 204 of the electronic system 100 of FIG. 1. The electronic system 100 can be an electronic platform for real property listings, transactions, or postings. For example, the electronic system 100 can be an online real estate marketplace, a rental property directory, a real property-focused social network, a real property search engine, or a combination thereof

As a more specific example, the electronic system 100 can be a social network of real property brokers, sellers, buyers, renters, investors, enthusiasts, or a combination thereof. As an additional example, the electronic system 100 can be a repository of real property listings. As yet another example, the electronic system 100 can be a rental property search engine.

The presentation graphic 204 is a display page for exhibiting real property listings. For example, the presentation graphic 204 can be a landing page, a homepage, a search result page or a combination thereof of the electronic system 100. The presentation graphic 204 can include a grid graphic 206, a map graphic 208, or a combination thereof. The grid graphic 206 is an arrangement of information concerning real property using rows, columns, or a combination thereof. The grid graphic 206 can include real property listings, real property posts, real property images, or a combination thereof arranged in a grid pattern. For example, the grid graphic 206 can depict images of real property listings in a 4×3 grid arrangement as shown in FIG. 2. The electronic system 100 can optimize the number of rows or columns of the grid graphic 206 based on the size of the display interface 202.

The map graphic 208 is an arrangement of information concerning real property on a map display. The map graphic 208 can include real property listings, real property posts, real property images, or a combination thereof arranged on a map display. For example, the map graphic 208 can arrange rental property listings on the map display by their addresses. The map graphic 208 can organize the rental property listings by attributes such as price, accommodations, size, or a combination thereof. As an additional example, the map graphic 208 can include images of for-sale properties by proximity to a geographic location. The map graphic 208 will be discussed in more detail in the following sections.

The presentation graphic 204 can depict a number of real property postings 210. The real property postings 210 are communications or notices concerning real property. For example, the real property postings 210 can be communications or notices concerning a real property asset 216. The real property asset 216 can include a house, a condominium, a commercial space, a building, a parking space, an easement, a work-space, a plot of land, an agricultural plot, a rental unit, or a combination thereof. For example, the real property postings 210 can include real-estate sales postings, commercial lease postings, land sale postings, work-space rental postings, or a combination thereof.

The real property postings 210 can refer to the information for the communications or notices displayed on the presentation graphic 204 or stored in a database. The real property postings 210 can be stored in the database when one or more instances of the real property postings 210 are removed from the presentation graphic 204. The electronic system 100 can remove the real property postings 210 when the real property asset 216 indicated in the real property postings 210 becomes the subject of a real property transaction 218. The real property transaction 218 is a pending or completed transaction involving real property. For example, a posting of a house for sale can be removed from the presentation graphic 204 when the house is in escrow.

The real property postings 210 can include a real property content 220. The real property content 220 is a text, image, or multimedia content concerning real property. For example, the real property content 220 can be an electronic image of a façade of the real property asset 216 indicated in one of the real property postings 210. As an additional example, the real property content 220 can be a video of an interior of the real property asset 216 indicated in another of the real property postings 210.

The presentation graphic 204 can display the real property postings 210 through a representative content 226. The representative content 226 are exemplary images, text, videos, audio content, or a combination thereof for representing a real property listing. For example, the representative content 226 can be an exemplary instance of the real property content 220. As a more specific example, the representative content 226 can include a thumbnail image of a façade of a house as depicted in FIG. 2. The thumbnail image can be chosen because it represents the best depiction of the house. As an additional example not shown in FIG. 2, the representative content 226 can include a panoramic video of a parcel of land.

The real property postings 210 can include a first real property post 212, a second real property post 214, or a combination thereof. The first real property post 212, the second real property post 214, or a combination thereof can be different instances of the real property postings 210. For example, the first real property post 212 can be a house for sale in Portland, Oregon as depicted in FIG. 2. In addition, the second real property post 214 can be a different house for sale in Portland, Oregon as depicted in FIG. 2. As an alternative example, the second real property post 214 can be a condominium for rent in Seattle, Washington.

The second real property post 214 can be a different instance of the real property asset 216 indicated in the first real property post 212. The second real property post 214 can also be the same instance of the real property asset 216 indicated in the first real property post 212 but presented in a different manner. For example, both the first real property post 212 and the second real property post 214 can involve a Victorian-style house in Portland, Oregon. The second real property post 214 can be a listing of the same Victorian-style indicated in the first real property post 212 but using different imagery or text to describe the Victorian-style house.

Each of the real property postings 210 can indicate preference indication inputs 228 from a user 240 of the electronic system 100. The user 240 can include a human user, a computing device, a virtual user, or a combination thereof. For example, the user 240 can include a real property buyer, seller, landlord, renter, broker, surveyor, banker, lender, investor, vendor, service provider, or a combination thereof. As an additional example, the user can include an electronic listing service, an online real estate platform, an electronic real estate directory, or a combination thereof.

The preference indication inputs 228 are interest signifying actions or inputs received at a real property listing or post. For example, the preference indication inputs 228 can be interest signifying actions or inputs received at one of the real property postings 210 to indicate the user 240's interest in the posting. As an additional example, the preference indication inputs 228 can be thumbs-up inputs applied to the representative content 226 to signify the user's interest in the real property asset 216 depicted in the representative content 226.

The preference indication inputs 228 can include view indicators 230, like indicators 232, or a combination thereof. The view indicators 230 are page, frame, or window views associated with a real property listing for signifying an interest in the real property listing. For example, the view indicators 230 can signify the user 240 opening a page, window, or frame associated with one of the real property postings 210. As an additional example, the view indicators 230 can require the user 240 to keep a page, window, or frame open for a predetermined time period.

The like indicators 232 are user inputs received at a real property listing for signifying an interest in the real property listing. For example, the like indicators 232 can involve click inputs, gesture inputs, touch inputs, swipe inputs, or a combination thereof applied to the real property postings 210. As a more specific example, the like indicators 232 can be received through a click input applied to a “Like” button associated with the real property postings 210. As an additional example, the like indicators 232 can be received through a touch input applied to a heart-shaped symbol associated with the real property postings 210.

The first real property post 212 can receive a first indication input 234. The first indication input 234 is one of the preference indication inputs 228 received at the first real property post 212. For example, the first indication input 234 can be a click input received on a thumbs-up symbol associated with the first real property post 212.

The second real property post 214 can receive a second indication input 236. The second indication input 236 is one of the preference indication inputs 228 received at the second real property post 214. For example, the second indication input 236 can be a swipe input received on a smiley-face symbol associated with the second real property post 214.

The electronic system 100 can increment one or more counters 238 associated with the preference indication inputs 228. The counters 238 can be presented on the presentation graphic 204 or in another window associated with the real property postings 210. For example, the counters 238 associated with the view indicators 230 for the first real property post 212 can increment when the user 240 opens an image file related to the first real property post 212.

Each of the real property postings 210 can receive the preference indication inputs 228 upon a posting 242. The posting 242 refers to a presentation of a real property listing for public display. For example, the posting 242 can refer to a submission of one of the real property postings 210. As a more specific example, the posting 242 can involve a seller submitting to the electronic system 100 information or images concerning a house for sale. In addition, the posting 242 can involve an electronic transfer of information or images from a database to the electronic system 100. As a more specific example, the posting 242 can involve an Extensible Markup Language (XML) feed of information or images from a multiple listing service (MLS) database.

The presentation graphic 204 can also display the real property postings 210 according to a property characteristic 244. The property characteristic 244 is an attribute of the real property asset 216 indicated in the real property postings 210. For example, the property characteristic 244 can include a price 246, a property type 248, a transaction type 250, an accommodation offering 252, or a combination thereof. The price 246 refers to the cost of the real property asset 216.

For example, the price 246 can be indicated as a price range or a fixed price. The property type 248 refers to a classification of the real property asset 216. For example, the property type 248 can include a house, a condominium, a plot of land, a farm, or a combination thereof. The transaction type 250 refers to the type of transaction desired by an owner or seller of the real property asset 216. For example, the transaction type 250 can include a rental, a bank-sale, a short sale, a foreclosure, a 30-day closing, or a combination thereof. The accommodation offering 252 refers to the type of accommodation offered by the real property asset 216. For example, the accommodation offering 252 can refer to a number of bedrooms, a number of bathrooms, a square footage, or a combination thereof.

The electronic system 100 can also apply a property filter 254 to the presentation graphic 204. The property filter 254 is a functionality for narrowing a set of real property listings. The property filter 254 can include a price filter 256, a property-type filter 258, a transaction-type filter 260, an accommodation filter 262, a keyword filter 264, or a combination thereof. The electronic system 100 can receive the property filter 254 from the user 240, a device in the electronic system 100, or a combination thereof. The property filter 254 can be implemented as part of the presentation graphic 204 as a dropdown menu, a slide bar, a text input box, or a combination thereof.

The price filter 256 is a set narrowing request based on a cost of real property. For example, the price filter 256 can increase or decrease the number of the real property postings 210 shown on the presentation graphic 204 based on the price 246 of the real property asset 216. As a more specific example, the user 240 can select from a drop-down menu to only view properties between $200,000 and $400,000.

The property-type filter 258 is a set narrowing request based on the type of real property. For example, the property-type filter 258 can be a request received by the electronic system 100 to increase or decrease the number of the real property postings 210 based on the property type 248. As a more specific example, the user 240 can select from a drop-down menu to only view condominiums for sale.

The transaction-type filter 260 is a set narrowing request based on the type of real property transaction. For example, the transaction-type filter 260 can increase or decrease the number of the real property postings 210 shown on the presentation graphic 204 based on the transaction type 250. As a more specific example, the user 240 can select from a drop-down menu to narrow down the real property postings 210 to only houses offered in a bank foreclosure sale.

The accommodation filter 262 is a set narrowing request based on an amenity or feature offered by the real property. For example, the accommodation filter 262 can increase or decrease the number of the real property postings 210 shown on the presentation graphic 204 based on the accommodation offering 252. The accommodation filter 262 can filter the real property postings 210 by the number of bedrooms, the square footage, the number of bathrooms, the fixtures, or a combination thereof.

The keyword filter 264 is a set narrowing request based on a text search string. For example, the keyword filter 264 can be a text search string received by the electronic system 100 concerning an aspect of the real property asset 216. The keyword filter 264 can be implemented through an input box 266 on the presentation graphic 204. As a more specific example, the keyword filter 264 can narrow the real property postings 210 down to only postings that satisfy the text search string: “condominium 2 car garage spacious.”

The electronic system 100 can arrange the presentation graphic 204 according to a ranking arrangement 268. The ranking arrangement 268 is an organizational scheme for displaying real property listings. For example, the ranking arrangement 268 can involve an ordering of the real property postings 210 based on the preference indication inputs 228.

As a more specific example, the ranking arrangement 268 can result in the first real property post 212 being displayed ahead of the second real property post 214 because the first real property post 212 received a greater number of the like indicators 232 than the second real property post 214. The ranking arrangement 268 can differ depending on whether the presentation graphic 204 is the map graphic 208, the grid graphic 206, or a combination thereof.

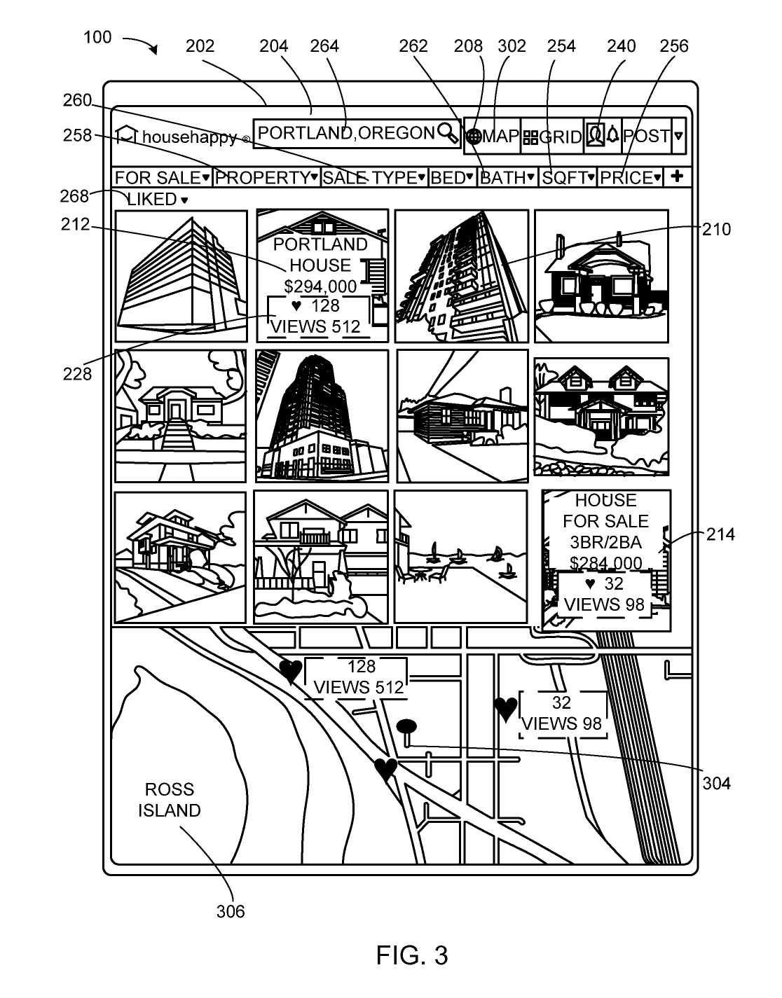

Referring now to FIG. 3 therein is shown another example of the display interface 202 of the first device 102. The display interface 202 can depict a portion of the presentation graphic 204 of the electronic system 100 as the map graphic 208. The map graphic 208 can show the first real property post 212, the second real property post 214, or a combination thereof on a map layout 302. The map layout 302 is a map of a region where a real property listing is located.

The presentation graphic 204 can show the real property postings 210 on the map graphic 208 using graphics, symbols, icons, text, or a combination thereof. The electronic system 100 can generate a different instance of the ranking arrangement 268 for the map graphic 208. For example, the electronic system 100 can display the real property postings 210 on the map graphic 208 based on a proximity to a specific location 304, a geographic region 306, or a combination thereof. The specific location 304 is a geographic location associated with an address, a coordinate, or a combination thereof. For example, the specific location 304 can be an address such as 123 Main Street. The specific location 304 can be received from the user 240, a device in the electronic system 100, or a combination thereof.

The geographic region 306 is a geographic area containing a real property listing. For example, the geographic region 306 can be a neighborhood, a town, a city, a county, a state, a province, or a combination thereof.

The electronic system 100 can further display the real property postings 210 on the map graphic 208 based on the preference indication inputs 228. For example, the map graphic 208 can show only the real property postings 210 with click inputs or page views above a threshold limit determined by the user 240, the electronic system 100, or a combination thereof. As a more specific example, the user 240 can choose to only see condominium listings on the map graphic 208 with 100 page views or above.

In addition, the electronic system 100 can filter the real property postings 210 on the map graphic 208 based on the property filter 254. For example, the map graphic 208 can display the real property postings 210 satisfying at least a portion of the price filter 256, the property-type filter 258, the transaction-type filter 260, the accommodation filter 262, the keyword filter 264, or a combination thereof. As a more specific example, the user 240 can choose to only see the map graphic 208 populated with apartment rentals for less than $2,000.

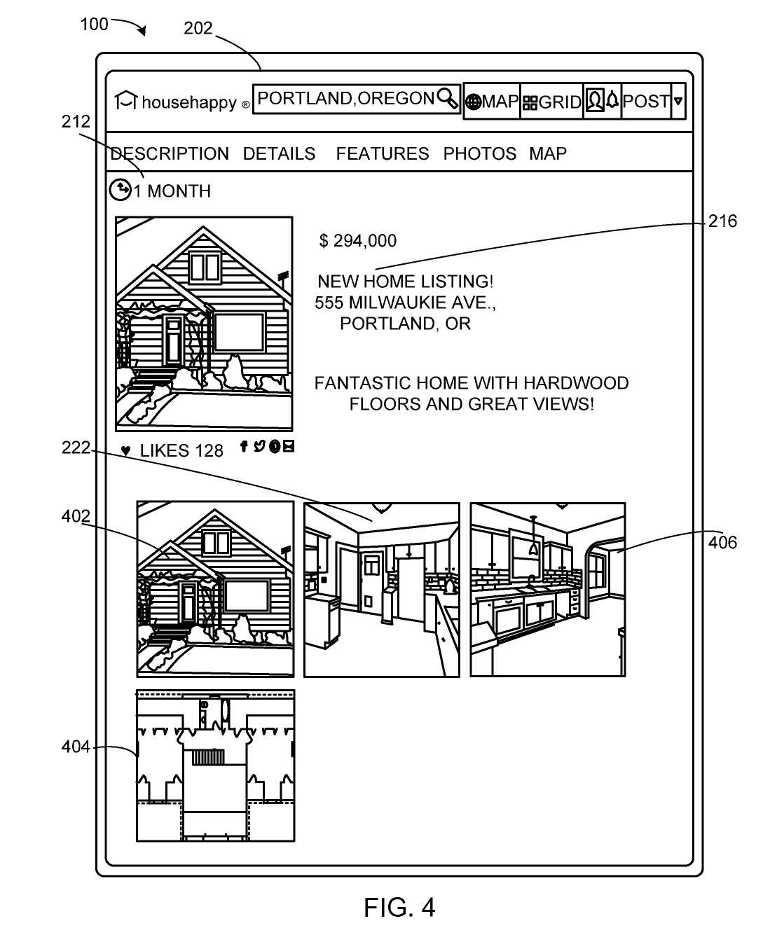

Referring now to FIG. 4 therein is shown another example of the display interface 202 of the first device 102. The display interface 202 can depict an exemplary instance of the first real property post 212. The first real property post 212 can include the first property content 222.

The first property content 222 can be classified by a content setting 402 of the first property content 222. The content setting 402 refers to an environment or a living space depicted in a real property image, video, or multimedia content. For example, the content setting 402 can include an environmental backdrop depicted in the first property content 222. As an additional example, the content setting 402 can be an accommodation of the real property asset 216, such as a room, a storage space, a structural space, or a combination thereof depicted in the first property content 222. In addition, the content setting 402 can include one or more fixtures of the real property asset 216 depicted in the first property content 222.

As a more specific example, the first property content 222 can be classified as kitchen photos, backyard videos, or front facing façade shots. In addition, the first property content 222 can be classified as natural-light photos, artificial-light videos, daytime videos, night-time photos, or a combination thereof.

The first property content 222 can also include a property plan 404 of the real property asset 216 indicated in the first real property post 212. The property plan 404 is a schematic of the exterior bounds, the interior layout, or a combination thereof of a property. For example, the property plan 404 can include a blueprint, a survey, a floor plan, or a combination thereof

When the first property content 222 involves visual content, the first property content 222 can be depicted from a vantage point 406. The vantage point 406 is a perception angle or a visual perspective of a real property image, video, or multimedia content. For example, the vantage point 406 can include a perspective view, a front view, an elevation view, a panoramic view, or a combination thereof. As a more specific example, the vantage point 406 can refer to an angle of a photograph depicting a kitchen of the real property asset 216. As an additional example, the vantage point 406 can refer to a depth perspective of the first property content 222.

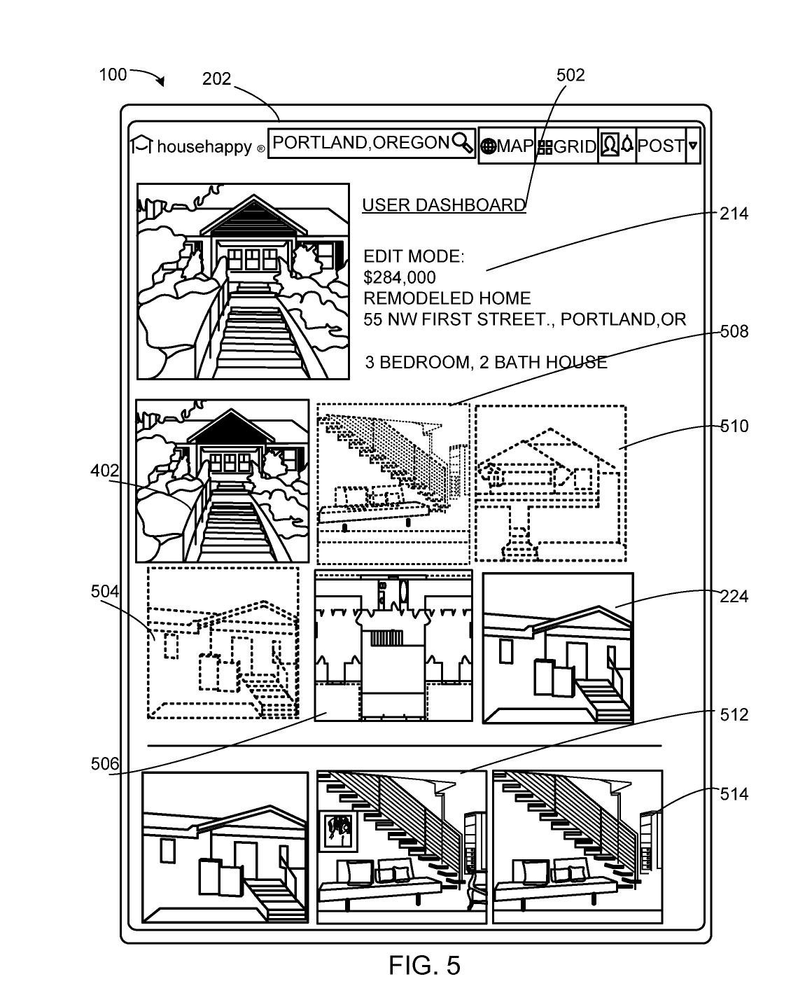

Referring now to FIG. 5 therein is shown another example of the display interface 202 of the first device 102. The display interface 202 can depict a user dashboard 502 associated with the second real property post 214. The user dashboard 502 is a graphic display allowing a user to make adjustments to a real property listing. For example, the user dashboard 502 can allow the user 240 to make adjustments to the second real property post 214.

The user dashboard 502 can include a proposed property content 504. The proposed property content 504 is a text, image, or multimedia content concerning a real property listing suggested by the electronic system 100. For example, the proposed property content 504 can be a text, image, or multimedia content suggested by the electronic system 100 concerning the second real property post 214. The proposed property content 504 can include a proposed property plan 506, a proposed interior content 508, a proposed exterior content 510, or a combination thereof

The proposed property plan 506 can be an instance of the property plan 404 suggested by the electronic system 100. For example, the proposed property plan 506 can include a blueprint, a survey, a floor plan, or a combination thereof of the real property asset 216 indicated in the second real property post 214. As a more specific example, the proposed property plan 506 can include a floor plan of a house associated with the second real property post 214.

The proposed interior content 508 is a text, image, or multimedia content concerning the interior of a piece of real property suggested by the electronic system 100. For example, the proposed interior content 508 can include a suggested image or video of a living space, a work space, a storage space, or a combination thereof. As a more specific example, the proposed interior content 508 can include a suggested image of a hallway associated with the second real property post 214.

The proposed exterior content 510 is a text, image, or multimedia content concerning the exterior of a piece of real property suggested by the electronic system 100. For example, the proposed exterior content 510 can include a suggested image or video of a façade of a structure, a yard area, or a combination thereof. As a more specific example, the proposed exterior content 510 can include a suggested image of a backyard associated with the second real property post 214.

The user dashboard 502 can also include a submitted content 512. The submitted content 512 is a text, image, or multimedia content concerning real property listing generated in response to a suggested content. For example, the submitted content 512 can be a text, image, or multimedia content concerning the second real property post 214 generated in response to the proposed property content 504.

As a more specific example, the submitted content 512 can be an image of a bedroom substantially matching an image of a bedroom depicted in the proposed property content 504. In addition, the submitted content 512 can be a video of a backyard substantially matching an image of a backyard depicted in the proposed property content 504.

The user dashboard 502 can further include a second property content 224. The second property content 224 is a text, image, or multimedia content concerning real property. In some instances, the second property content 224 can be the submitted content 512.

The proposed property content 504, the submitted content 512, the second property content 224, or a combination thereof can also be classified by the content setting 402. For example, the second property content 224 can be classified by a location of the content, such as an interior location, an exterior location, or a combination thereof. In addition, the submitted content 512 can be classified by the amount of natural lighting, artificial lighting, or a combination thereof shown in the second property content 224.

The user dashboard 502 can further depict a revised proposed content 514. The revised proposed content 514 is content concerning a real property listing suggested by the electronic system 100. The proposed content 514 can include a text, an image, or a multimedia content concerning a real property listing suggested by the electronic system 100 in response to the second property content 224. For example, the revised proposed content 514 can be an revised instance of proposed property content 504.

As a more specific example, the revised proposed content 514 can be a second image of a kitchen interior if the first image of a kitchen interior submitted by the user 240 as the second property content 224 does not substantially match or mimic the proposed property content 504 suggested by the electronic system 100. The electronic system 100 can compare the second property content 224 with the proposed property content 504 and generate the revised proposed content 514 based on the comparison.

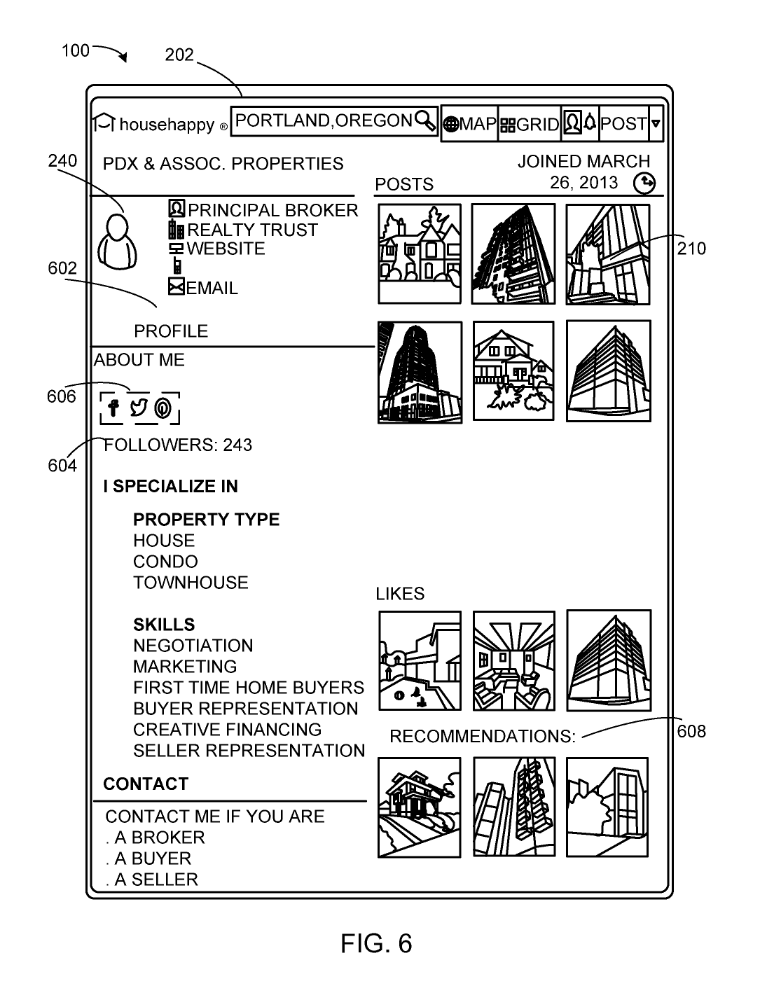

Referring now to FIG. 6 therein is shown another example of the display interface 202 of the first device 102. The display interface 202 can depict a user profile 602 associated with the user 240 of the electronic system 100. The user profile 602 is a display page allowing a user to manage an online persona of the user and view recommendations for real property listings. For example, the user profile 602 can be an interface allowing the user 240 to view real property postings 210 recommended by the electronic system 100.

The user profile 602 can depict the followers 604 of the user 240, the social network contacts 606 of the user 240, or a combination thereof. The followers 604 are one set or group of users following the activities of another set or group of users. For example, the followers 604 of the user 240 can be other users of the electronic system 100 indicating an interest in the activities of the user 240 with respect to the real property postings 210. For example, the followers 604 can include the user 240's acquaintances, business associates, service providers, vendors, or a combination thereof. The electronic system 100 can receive a request to follow the user 240 through a command or input applied to the user profile 602 of the user 240.

The electronic system 100 can update the followers 604 on the preference indication inputs 228 of FIG. 2 attributed to the user 240. For example, a first user can be one of the followers 604 of a second user. The electronic system 100 can inform the first user of the real property postings 210 viewed by the second user in the last five days.

The social network contacts 606 are friends, acquaintances, or colleagues of the user 240 connected to the user 240 through a social network. The electronic system 100 can update the social network contacts 606 of the user 240 concerning the activities of the user 240 with respect to the real property postings 210. For example, the electronic system 100 can send a notification to a Facebook™ friend of the user 240 when the user 240 likes one of the real property postings 210. In the case where the electronic system 100 is a real property-focused social network, the followers 604 of the user can also be the social network contacts 606 of the user.

The electronic system 100 can also provide a recommendation 608 to the user 240, the followers 604 of the user 240, the social network contacts 606 of the user 240, or a combination thereof. The recommendation 608 is a suggested real property posting based on a preference of a user. The electronic system 100 can provide the recommendation 608 based on the activities of the user 240.

For example, the recommendation 608 can be a suggestion for a condominium listing based on the like indicators 232 of FIG. 2 of the user 240 concerning other condominium listings. As an additional example, the recommendation 608 can be a suggestion for a land parcel listing based on the view indicators 230 of FIG. 2 attributed to the user 240 concerning other land parcels.

The electronic system 100 can provide the recommendation 608 through a message, a notification, an alert, or a combination thereof directed at the user 240, the followers 604 of the user 240, the social network contacts 606 of the user 240, or a combination thereof. In addition, the electronic system 100 can provide the recommendation 608 through the user profile 602 of the user 240, the user profile 602 of one of the followers 604 of the user 240, the user profile 602 of one of the social network contacts 606 of the user 240, or a combination thereof.

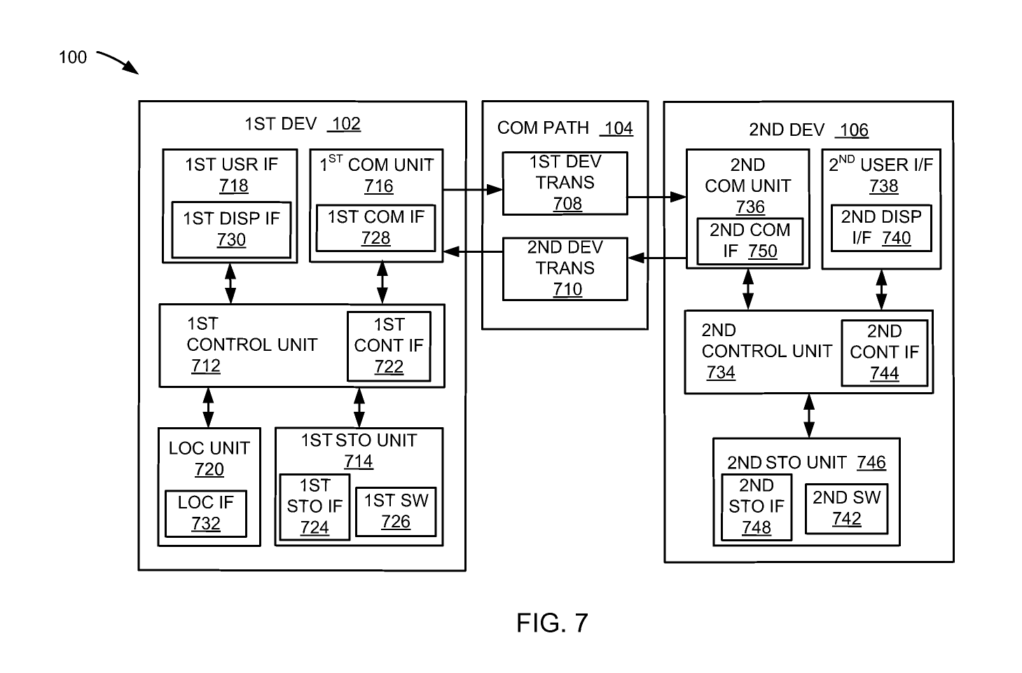

Referring now to FIG. 7 therein is shown an exemplary block diagram of the electronic system 100. The electronic system 100 can include the first device 102, the communication path 104, and the second device 106. The first device 102 can send information in a first device transmission 708 over the communication path 104 to the second device 106. The second device 106 can send information in a second device transmission 710 over the communication path 104 to the first device 102.

For illustrative purposes, the electronic system 100 is shown with the first device 102 as a client device, although it is understood that the electronic system 100 can have the first device 102 as a different type of device. For example, the first device 102 can be a server.

Also for illustrative purposes, the electronic system 100 is shown with the second device 106 as a server, although it is understood that the electronic system 100 can have the second device 106 as a different type of device. For example, the second device 106 can be a client device.

For brevity of description in this embodiment of the present invention, the first device 102 will be described as a client device and the second device 106 will be described as a server device. The present invention is not limited to this selection for the type of devices. The selection is an example of the present invention.

The first device 102 can include a first control unit 712, a first storage unit 714, a first communication unit 716, a first user interface 718, and a location unit 720. The first device 102 can be similarly described by the first device 102.

The first control unit 712 can include a first control interface 722. The first control unit 712 can execute a first software 726 to provide the intelligence of the electronic system 100. The first control unit 712 can be implemented in a number of different manners. For example, the first control unit 712 can be a processor, an embedded processor, a microprocessor, a hardware control logic, a hardware finite state machine (FSM), a digital signal processor (DSP), or a combination thereof. The first control interface 722 can be used for communication between the first control unit 712 and other functional units in the first device 102. The first control interface 722 can also be used for communication that is external to the first device 102.

The first control interface 722 can receive information from the other functional units or from external sources, or can transmit information to the other functional units or to external destinations. The external sources and the external destinations refer to sources and destinations external to the first device 102.

The first control interface 722 can be implemented in different ways and can include different implementations depending on which functional units or external units are being interfaced with the first control interface 722. For example, the first control interface 722 can be implemented with a pressure sensor, an inertial sensor, a microelectromechanical system (MEMS), optical circuitry, waveguides, wireless circuitry, wireline circuitry, or a combination thereof.

The location unit 720 can generate a location information, a current heading, and a current speed of the first device 102, as examples. The location unit 720 can be implemented in many ways. For example, the location unit 720 can function as at least a part of a global positioning system (GPS), an inertial navigation system, a cellular-tower location system, a pressure location system, or any combination thereof

The location unit 720 can include a location interface 732. The location interface 732 can be used for communication between the location unit 720 and other functional units in the first device 102. The location interface 732 can also be used for communication that is external to the first device 102.

The location interface 732 can receive information from the other functional units or from external sources, or can transmit information to the other functional units or to external destinations. The external sources and the external destinations refer to sources and destinations external to the first device 102.

The location interface 732 can include different implementations depending on which functional units or external units are being interfaced with the location unit 720. The location interface 732 can be implemented with technologies and techniques similar to the implementation of the first control interface 722.

The first storage unit 714 can store the first software 726. The first storage unit 714 can also store the relevant information, such as advertisements, point of interest (POI), navigation routing entries, reviews/ratings, feedback, traffic patterns, or any combination thereof.

The first storage unit 714 can be a volatile memory, a nonvolatile memory, an internal memory, an external memory, or a combination thereof. For example, the first storage unit 714 can be a nonvolatile storage such as non-volatile random access memory (NVRAM), Flash memory, disk storage, or a volatile storage such as static random access memory (SRAM).

The first storage unit 714 can include a first storage interface 724. The first storage interface 724 can be used for communication between the location unit 720 and other functional units in the first device 102. The first storage interface 724 can also be used for communication that is external to the first device 102.

The first storage interface 724 can receive information from the other functional units or from external sources, or can transmit information to the other functional units or to external destinations. The external sources and the external destinations refer to sources and destinations external to the first device 102.

The first storage interface 724 can include different implementations depending on which functional units or external units are being interfaced with the first storage unit 714. The first storage interface 724 can be implemented with technologies and techniques similar to the implementation of the first control interface 722.

The first communication unit 716 can enable external communication to and from the first device 102. For example, the first communication unit 716 can permit the first device 102 to communicate with the second device 106 of FIG. 1, an attachment, such as a peripheral device or a computer desktop, and the communication path 104.

The first communication unit 716 can also function as a communication hub allowing the first device 102 to function as part of the communication path 104 and not limited to be an end point or terminal unit to the communication path 104. The first communication unit 716 can include active and passive components, such as microelectronics or an antenna, for interaction with the communication path 104.

The first communication unit 716 can include a first communication interface 728. The first communication interface 728 can be used for communication between the first communication unit 716 and other functional units in the first device 102. The first communication interface 728 can receive information from the other functional units or can transmit information to the other functional units.

The first communication interface 728 can include different implementations depending on which functional units are being interfaced with the first communication unit 716. The first communication interface 728 can be implemented with technologies and techniques similar to the implementation of the first control interface 722.

The first user interface 718 allows a user (not shown) to interface and interact with the first device 102. The first user interface 718 can include an input device and an output device. Examples of the input device of the first user interface 718 can include a keypad, a touchpad, soft-keys, a keyboard, a microphone, or any combination thereof to provide data and communication inputs.

The first user interface 718 can include a first display interface 730. The first display interface 730 can include a display, a projector, a video screen, a speaker, or any combination thereof.

The first control unit 712 can operate the first user interface 718 to display information generated by the electronic system 100. The first control unit 712 can also execute the first software 726 for the other functions of the electronic system 100, including receiving location information from the location unit 720. The first control unit 712 can further execute the first software 726 for interaction with the communication path 104 via the first communication unit 716.

The second device 106 can be optimized for implementing the present invention in a multiple device embodiment with the first device 102. The second device 106 can provide the additional or higher performance processing power compared to the first device 102. The second device 106 can include a second control unit 734, a second communication unit 736, and a second user interface 738.

The second user interface 738 allows the user to interface and interact with the second device 106. The second user interface 738 can include an input device and an output device. Examples of the input device of the second user interface 738 can include a keypad, a touchpad, soft-keys, a keyboard, a microphone, or any combination thereof to provide data and communication inputs. Examples of the output device of the second user interface 738 can include a second display interface 740. The second display interface 740 can include a display, a projector, a video screen, a speaker, or any combination thereof

The second control unit 734 can execute a second software 742 to provide the intelligence of the second device 106 of the electronic system 100. The second software 742 can operate in conjunction with the first software 726. The second control unit 734 can provide additional performance compared to the first control unit 712.

The second control unit 734 can operate the second user interface 738 to display information. The second control unit 734 can also execute the second software 742 for the other functions of the electronic system 100, including operating the second communication unit 736 to communicate with the first device 102 over the communication path 104.

The second control unit 734 can be implemented in a number of different manners. For example, the second control unit 734 can be a processor, an embedded processor, a microprocessor, a hardware control logic, a hardware finite state machine (FSM), a digital signal processor (DSP), or a combination thereof.

The second control unit 734 can include a second controller interface 444. The second controller interface 444 can be used for communication between the second control unit 734 and other functional units in the second device 106. The second controller interface 444 can also be used for communication that is external to the second device 106.

The second controller interface 444 can receive information from the other functional units or from external sources, or can transmit information to the other functional units or to external destinations. The external sources and the external destinations refer to sources and destinations external to the second device 106.

The second controller interface 444 can be implemented in different ways and can include different implementations depending on which functional units or external units are being interfaced with the second controller interface 444. For example, the second controller interface 444 can be implemented with a pressure sensor, an inertial sensor, a microelectromechanical system (MEMS), optical circuitry, waveguides, wireless circuitry, wireline circuitry, or a combination thereof.

A second storage unit 746 can store the second software 742. The second storage unit 746 can also store the relevant information, such as advertisements, points of interest, navigation routing entries, reviews/ratings, feedback, traffic patterns, or any combination thereof. The second storage unit 746 can be sized to provide the additional storage capacity to supplement the first storage unit 714.

For illustrative purposes, the second storage unit 746 is shown as a single element, although it is understood that the second storage unit 746 can be a distribution of storage elements. Also for illustrative purposes, the electronic system 100 is shown with the second storage unit 746 as a single hierarchy storage system, although it is understood that the electronic system 100 can have the second storage unit 746 in a different configuration. For example, the second storage unit 746 can be formed with different storage technologies forming a memory hierarchal system including different levels of caching, main memory, rotating media, or off-line storage.

The second storage unit 746 can be a volatile memory, a nonvolatile memory, an internal memory, an external memory, or a combination thereof. For example, the second storage unit 746 can be a nonvolatile storage such as non-volatile random access memory (NVRAM), Flash memory, disk storage, or a volatile storage such as static random access memory (SRAM).

The second storage unit 746 can include a second storage interface 748. The second storage interface 748 can be used for communication between the location unit 720 and other functional units in the second device 106. The second storage interface 748 can also be used for communication that is external to the second device 106.

The second storage interface 748 can receive information from the other functional units or from external sources, or can transmit information to the other functional units or to external destinations. The external sources and the external destinations refer to sources and destinations external to the second device 106.

The second storage interface 748 can include different implementations depending on which functional units or external units are being interfaced with the second storage unit 746. The second storage interface 748 can be implemented with technologies and techniques similar to the implementation of the second controller interface 444.

The second communication unit 736 can enable external communication to and from the second device 106. For example, the second communication unit 736 can permit the second device 106 to communicate with the first device 102 over the communication path 104.

The second communication unit 736 can also function as a communication hub allowing the second device 106 to function as part of the communication path 104 and not limited to be an end point or terminal unit to the communication path 104. The second communication unit 736 can include active and passive components, such as microelectronics or an antenna, for interaction with the communication path 104.

The second communication unit 736 can include a second communication interface 750. The second communication interface 750 can be used for communication between the second communication unit 736 and other functional units in the second device 106. The second communication interface 750 can receive information from the other functional units or can transmit information to the other functional units.

The second communication interface 750 can include different implementations depending on which functional units are being interfaced with the second communication unit 736. The second communication interface 750 can be implemented with technologies and techniques similar to the implementation of the second controller interface 444.

The first communication unit 716 can couple with the communication path 104 to send information to the second device 106 in the first device transmission 708. The second device 106 can receive information in the second communication unit 736 from the first device transmission 708 of the communication path 104.

The second communication unit 736 can couple with the communication path 104 to send information to the first device 102 in the second device transmission 710. The first device 102 can receive information in the first communication unit 716 from the second device transmission 710 of the communication path 104. The electronic system 100 can be executed by the first control unit 712, the second control unit 734, or a combination thereof.

For illustrative purposes, the second device 106 is shown with the partition having the second user interface 738, the second storage unit 746, the second control unit 734, and the second communication unit 736, although it is understood that the second device 106 can have a different partition. For example, the second software 742 can be partitioned differently such that some or all of its function can be in the second control unit 734 and the second communication unit 736. Also, the second device 106 can include other functional units not shown in FIG. 3 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the electronic system 100 is described by operation of the first device 102 and the second device 106. It is understood that the first device 102 and the second device 106 can operate any of the modules and functions of the electronic system 100. For example, the first device 102 is described to operate the location unit 720, although it is understood that the second device 106 can also operate the location unit 720.

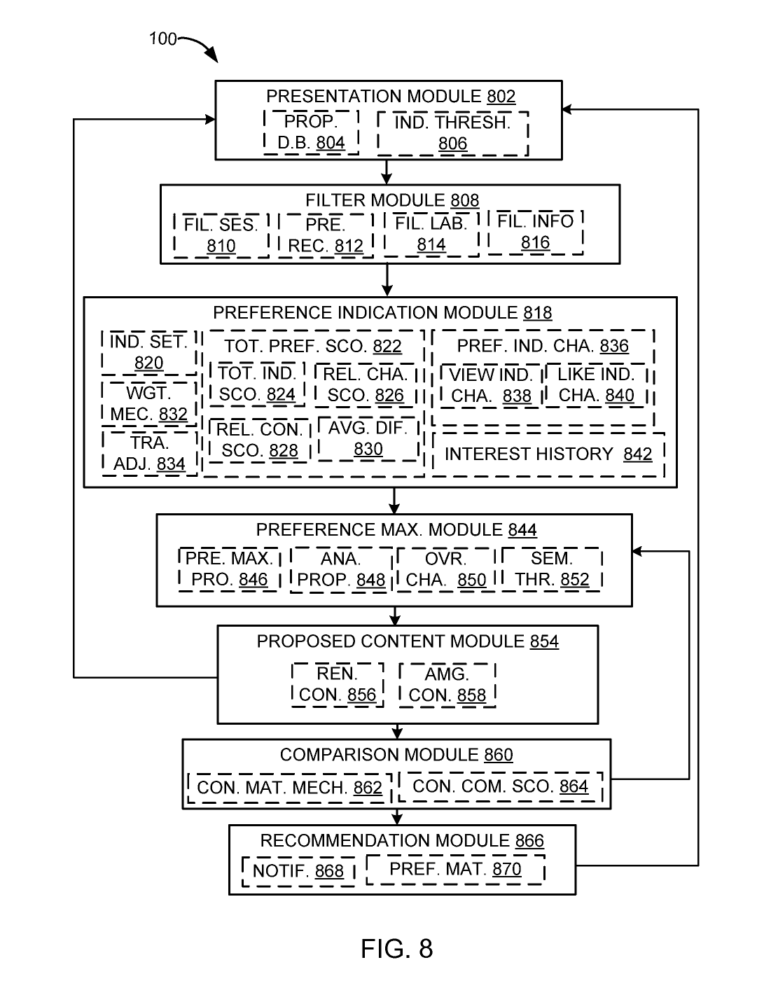

Referring now to FIG. 8, therein is shown a control flow of the electronic system 100 with a real property preference mechanism. The electronic system 100 can include a presentation module 802, a filter module 808, a preference indication module 818, preference maximization module 844, a proposed content module 854, a comparison module 860, a recommendation module 866, or a combination thereof

The modules noted above and below are coupled to one another by having an operation of one module influence an operation of another module or other modules, by having an output of one module as an input of another module or other modules using wired or wireless connections, or a combination thereof

The presentation module 802 is for generating and arranging the presentation graphic 204 of FIG. 2. The presentation module 802 can generate the presentation graphic 204 by extracting images, text, videos, audio content, or a combination thereof from the real property postings 210 for display through the presentation graphic 204. For example, the presentation module 802 can display an image from the first real property post 212 of FIG. 2 as a thumbnail in the grid graphic 206 of FIG. 2. As an additional example, the presentation module 802 can display a video from the second real property post 214 of FIG. 2 as a pop-up video thumbnail in the map graphic 208 of FIG. 2.

The presentation graphic 204 can be implemented using a variety markup and scripting languages or tools. For example, the presentation graphic 204 can be implemented using the Ruby™ programming language, HyperText Markup Language (HTML), Cascading Style Sheets (CSS), XML, JavaScript, or a combination thereof. In addition, the presentation module 802 can enhance the visual appeal of the presentation graphic 204 using formatters, beautifiers, or a combination thereof. As a more specific example, a JavaScript formatter such as jsbeautifier can be used to enhance the presentation graphic 204.

The presentation module 802 can be part of the first software 726 of FIG. 7, the second software 742 of FIG. 7, or a combination thereof. The first control unit 712 of FIG. 7 can execute the first software 726, the second control unit 734 of FIG. 7 can execute the second software 742, or a combination thereof to generate the presentation graphic 204. The presentation module 802 can also receive the real property postings 210 from the user 240 of FIG. 2 through the first user interface 718 of FIG. 7, the first display interface 730 of FIG. 7, the second user interface 738 of FIG. 7, the second display interface 740 of FIG. 7, or a combination thereof

The presentation module 802 can also interact with a real property database, such as MLS, to receive the real property postings 210 through the first communication unit 716 of FIG. 7, the first control interface 728 of FIG. 7, the second communication unit 736 of FIG. 7, the second communication interface 750 of FIG. 7, or a combination thereof. The presentation module 802 can also use an image converter, such as CarrierWave™, to convert an image file received as part of the submission into a desired format.

The presentation module 802 can store the real property postings 210, the real property content 220, or a combination thereof in a property database 804. As examples, the property database 804 can be implemented as a relational database, a key-value database, an array database, a columnar database, an object oriented database, or a combination thereof. The presentation module 802 can store the property database 804 in the first storage unit 714, the second storage unit 746, or a combination thereof

The presentation module 802 can display the real property postings 210 through the grid graphic 206, the map graphic 208, or a combination thereof. The presentation module 802 can generate the grid graphic 206 by determining an appropriate size for the grid graphic 206. The presentation module 802 can determine the appropriate size for the grid graphic 206 by optimizing the number of rows or columns of the grid graphic 206 based on the size of a display interface, such as the first display interface 730, the second display interface 740, or a combination thereof.

When displaying the real property postings 210 through the grid graphic 206, the presentation module 802 can represent each of the real property postings 210 using the representative content 226 of FIG. 2. The presentation module 802 can initially set the size of the representative content 226 based on a default dimension. For example, the default dimension can be 125 pixels by 125 pixels.

The presentation module 802 can receive a command by the user 240, a device in the electronic system 100, another device, or a combination thereof to increase or decrease the size of the representative content 226, the number of columns of the grid graphic 206, the number of rows of the grid graphic 206, or a combination thereof. The presentation module 802 can receive the command through a slide bar mechanism. The presentation module 802 can also determine the size of the representative content 226, the grid graphic 206, or a combination thereof using a sizing algorithm.

The presentation module 802 can arrange the grid graphic 206 by a timing of the posting 242 of FIG. 2. For example, the presentation module 802 can display the first real property post 212 above the second real property post 214 because the first real property post 212 was posted before the second real property post 214. In addition, the presentation module 802 can also arrange the grid graphic 206 based on the ranking arrangement 268 of FIG. 2.

The presentation module 802 can generate the ranking arrangement 268 based on the amount of the preference indication inputs 228 received. For example, the presentation module 802 can arrange the first real property post 212 ahead of the second real property post 214 when the first real property post 212 receives a greater number of page views than the second real property post 214. The presentation module 802 can arrange the first real property post 212 ahead of the second real property post 214 by displaying the first real property post 212 closer to the top of the grid graphic 206.

The presentation module 802 can also display the real property postings 210 through the map graphic 208. The first control unit 712 can execute the first software 726, the second control unit 734 can execute the second software 742, or a combination thereof to generate the map graphic 208 and interact with a map database to retrieve the map layout 302 of FIG. 3.

The map database can be provided by a mapping application such as Google Maps™, Navteg™, or a combination thereof. In addition, the map database can be a third-party database such as a Geographic Information System (GIS) database, a Global Navigation Satellite System (GNSS) database, or a combination thereof. The presentation module 802 can interface with the mapping application through an application programming interface (API).

The presentation module 802 can display the real property postings 210 on the map layout 302 based on their proximity to the specific location 304, their presence in the geographic region 306, or a combination thereof. For example, the geographic region 306 can be a neighborhood in Portland, Oregon called the “Pearl District.” The presentation module 802 can then display all of the real property postings 210 within the Pearl District on the map layout 302.

The presentation module 802 can generate a different instance of the ranking arrangement 268 for the map graphic 208. The presentation module 802 can generate the ranking arrangement 268 for the map graphic 208 by excluding the real property postings 210 incapable of receiving enough of the preference indication inputs 228 to exceed an indication threshold 806. The indication threshold 806 is a minimum amount of views or interest indicators needed for a property to be displayed in the presentation graphic 204.

For example, the indication threshold 806 can be an absolute quantity, such as 100 views, or a quantity dictated by time, such as 50 views in a month. The indication threshold 806 can be predetermined by the electronic system 100 or received from the user 240. The presentation module 802 can display the map graphic 208 on the same interface as the grid graphic 206. For example, as depicted in FIG. 3, the presentation module 802 can display both the map graphic 208 and the grid graphic 206 on the display interface 202.

The presentation module 802 can communicate or receive the real property postings 210, the presentation graphic 204, the ranking arrangement 268, or a combination thereof between devices through the first communication unit 716, the second communication unit 736, or a combination thereof.

After generating and arranging the presentation graphic 204, the control flow can pass from the presentation module 802 to the filter module 808. The control flow can pass by having the real property postings 210, the presentation graphic 204, the ranking arrangement 268, or a combination thereof as an output from the presentation module 802 to an input of the filter module 808.

The filter module 808 is for applying filters to a property database and analyzing the filters applied. The filter module 808 can apply the property filter 254 to the property database 804 to increase or decrease the number of the real property postings 210 displayed in the presentation graphic 204. For example, the user 240 can apply the price filter 256 of “<$200,000” and the property-type filter 258 of “condominium” to view only the real property postings 210 of condominiums under $200,000.

The filter module 808 can be part of the first software 726, the second software 742, or a combination thereof. The first control unit 712 can execute the first software 726, the second control unit 734 can execute the second software 742, or a combination thereof to receive a command or input from the user 240 concerning the property filter 254. The filter module 808 can also receive the property filter 254 from a device in the electronic system 100.

The property filter 254 can be implemented as a dropdown menu, a slide bar, a text input box, or a combination thereof. For example, the user 240 can select from a drop-down menu to apply the accommodation filter 262 and manipulate a slide bar to apply the price filter 256.

The filter module 808 can apply the property filter 254 in combination with the ranking arrangement 268. For example, the presentation module 802 can first rank the real property postings 210 by the number of the preference indication inputs 228 and the filter module 808 can then apply the price filter 256 to the ranked postings.

The filter module 808 can track the activity of the user 240 by monitoring a filtered session 810 when the property filter 254 is applied to the electronic system 100. The filtered session 810 involve user activities on the electronic system 100 after the property filter 254 is applied. The filtered session 810 can be associated with the user 240, a device, a plurality of users, a demographic group, or a combination thereof

The filter module 808 can generate a preference record 812 when monitoring the filtered session 810. The preference record 812 is a log or chronicle of the real property postings 210 receiving the preference indication inputs 228 once the property filter 254 is applied.

For example, the user 240 can apply the transaction-type filter 260 of “bank foreclosure sale” at the outset of an activity session on the electronic system 100. In this example, the preference record 812 can include a record of the real property postings 210 viewed or “Liked” by the user 240 once the transaction-type filter 260 is applied.

The filter module 808 can generate the preference record 812 by assigning a filter label 814 to the preference indication inputs 228 detected after the property filter 254 is applied. The filter label 814 is an identifier or tag for associating a preference indication with a filter. For example, the filter label 814 can include the name of the property filter 254, the type of the property filter 254, or a combination thereof. For example, the filter module 808 can assign the filter label 814 of “<$200,000” to one of the like indicators 232 received at a picture of a house listed for $180,000.

The filter module 808 can end the filtered session 810 when a new instance of the property filter 254 is applied. Alternatively, the filter module 808 can continue monitoring the filtered session 810 when a new instance of the property filter 254 is applied. By doing so, the filter module 808 can associate multiple instances of the property filter 254 with the preference indication inputs 228, the preference record 812, or a combination thereof. For example, the filter module 808 can assign the filter label 814 of “ranch; >$500,000” to one of the view indicators 230 received at a video of a farm listed for $600,000.

The filter module 808 can also classify the filtered session 810, the preference record 812, or a combination thereof using filter information 816. The filter information 816 is contextual information or metadata concerning filters. For example, the filter information 816 can include a time-of-day when the property filter 254 was applied, a time-of-day when the preference indication inputs 228 was received after the application of the property filter 254, a time interval between the application of the property filter 254 and the receipt of the preference indication inputs 228, or a combination thereof

The first control unit 712 can execute the first software 726, the second control unit 734 can execute the second software 742, or a combination thereof to monitor the filtered session 810 and generate the preference record 812, the filter information 816, or a combination thereof. In addition, the filter module 808 can store the preference record 812, the filter label 814, the filter information 816, or a combination thereof in the first storage unit 714, the second storage unit 748, or a combination thereof

The filter module 808 can communication or receive the filtered session 810, the preference record 812, the filter label 814, the filter information 816, or a combination thereof between devices through the first communication unit 716, the second communication unit 736, or a combination thereof.

After applying and analyzing the property filter 254, the control flow can pass from the filter module 808 to the preference indication module 818. The control flow can pass by having the filtered session 810, the preference record 812, the filter label 814, the filter information 816, or a combination thereof as an output from the filter module 808 to an input of the preference indication module 818.

The preference indication module 818 is for classifying and analyzing interest indications in real property listings. For example, the preference indication module 818 can classify and analyze the preference indication inputs 228 received by the real property postings 210, the real property content 220, or a combination thereof

The preference indication module 818 can classify the preference indication inputs 228 by generating an indicator set 820. The indicator set 820 is a log or record of the preference indication inputs 228 classified by the property characteristic 244, the specific location 304, the geographic region 306 of the real property asset 216, or a combination thereof indicated in the real property postings 210. For example, the indicator set 820 can include a record of the like indicators 232 received by foreclosed houses displayed on the presentation graphic 204. As an additional example, the indicator set 820 can include a log of the view indicators 230 received by 2-bedroom condominium rentals from the last 12 months.

The preference indication module 818 can use tags, clusters, identifiers, flags, or a combination thereof to generate the indicator set 820. The preference indication module 818 can be part of the first software 726, the second software 742, or a combination thereof. The first control unit 712 can execute the first software 726, the second control unit 734 can execute the second software 742, or a combination thereof to generate the indicator set 820.

The preference indication module 818 can analyze the preference indication inputs 228 by calculating a total preference score 822 for each of the real property postings 210, the real property content 220, or a combination thereof. The total preference score 822 is a numerical representation of the interest received by a real property content or post. For example, the total preference score 822 can be a numerical representation of the preference indication inputs 228 received by the real property postings 210, the real property content 220, or a combination thereof.

The total preference score 822 can include a total indicator score 824, a relative characteristic score 826, a relative content score 828, an average differential 830, or a combination thereof. The total indicator score 824 is a numerical representation of the view indicators 230, the like indicators 232, or a combination thereof received by the real property postings 210, the real property content 220, or a combination thereof. For example, the total indicator score 824 can represent the absolute number of page view or likes received by an image displayed on one of the real property postings 210.

Alternatively, the total indicator score 824 can be subjected to a weighting mechanism 832. The weighting mechanism 832 is a numerical adjustment of a calculated result based on numerical weights assigned to variables. For example, the preference indication module 818 can assign more weight to the like indicators 232 than the view indicators 230 using the weighting mechanism 832. As a more specific example, an image of a house can receive 10 points when a user clicks on a “Like” button and only 1 point when a user enlarges a thumbnail of the image.

The total indicator score 824 can be calculated for each of the real property postings 210, the real property content 220 presented in the real property postings 210, or a combination thereof. When the total indicator score 824 is calculated for one of the real property postings 210, the total indicator score 824 can be a cumulative score encompassing the total indicator score 824 for each the real property content 220 associated with one of the real property postings 210. For example, the total indicator score 824 for one of the real property postings 210 can include the total indicator score 824 for each of the images associated with the posting.

The relative characteristic score 826 is a numerical representation of interest indication in a property post or content based on a characteristic or location of the property indicated in the property post or content. For example, the relative characteristic score 826 can be a numerical representation of the preference indication inputs 228 of the real property postings 210, the real property content 220, or a combination thereof relative to other postings or content having the same instance of the property characteristic 244, the specific location 304, the geographic region 306, or a combination thereof

For example, the relative characteristic score 826 can be the total number of page views received by an image of a land parcel relative to other images based on the same property type or price. As an additional example, the relative characteristic score 826 can be the number of likes received by a posting concerning a condominium in a particular neighborhood relative to other postings of dwellings in the same neighborhood.

The relative characteristic score 826 can be calculated as an absolute difference, a percentage difference, a range value, a greater-than or less-than condition, or a combination thereof. Similar to the total indicator score 824, the relative characteristic score 826 can also be subjected to the weighting mechanism 832.

The relative content score 828 is a numerical representation of interest indication in a real property image, video, or multimedia content relative to other real property images, videos, or multimedia. For example, the relative content score 828 can be a numerical representation of the preference indication inputs 228 of an instance of the real property content 220 relative to other instances of the real property content 220. The preference indication module 818 can calculate the relative content score 828 based on the content setting 402, the vantage point 406, or a combination thereof.

For example, the relative content score 828 can be the total number of page views received by a panoramic image of a kitchen relative to other panoramic images. As an additional example, the relative content score can be the number of likes received by a video of a backyard at nighttime relative to other nighttime real property videos. Similar to the total indicator score 824 and the relative characteristic score 826, the relative content score 828 can also be subjected to the weighting mechanism.

The average differential 830 is a numerical representation of interest indication in a real property post or content relative to an average indication. The preference indication module 818 can calculate instances of the average differential 830 for the total indicator score 824, the relative characteristic score 826, the relative content score 828, or a combination thereof. For example, the average differential 830 can be the total indicator score 824 for one of the real property postings 210 relative to an average instance of the total indicator score 824 for all of the real property postings 210.

As another example, the average differential 830 can be the number of likes received by an image of a kitchen interior in a two bedroom house relative to the average number of likes received by all images of kitchen interiors in two bedroom houses. As yet another example, the average differential 830 can be the number of page views received by a panoramic picture of a backyard relative to the average number of page views received by all panoramic pictures of backyards.

The preference indication module 818 can calculate the average differential 830 as an absolute difference, a percentage difference, a range value, a greater-than or less-than condition, or a combination thereof. The total preference score can also apply the weighting mechanism 832 to the calculation of the average differential 830.

In addition, the preference indication module 818 can also apply a transaction adjustment 834 to the total indicator score 824, the relative characteristic score 826, the relative content score 828, the average differential 830 or a combination thereof based on the real property transaction 218. For example, the preference indication module 818 can apply the transaction adjustment 834 to the total indicator score 824 of one of the real property postings 210 if this particular post was removed from the presentation graphic 204 because the real property asset 216 depicted in the post was involved in a property transaction.

As a more specific example, the preference indication module 818 can apply the transaction adjustment 834 to the total indicator score 824 of a post for a Victorian house if the Victorian house was recently sold. The electronic system 100 can be informed of the real property transaction 218 from the user 240, a device in the electronic system 100, or a combination thereof.

In addition, the transaction adjustment 834 can involve an increase or decrease to the total indicator score 824, the relative characteristic score 826, the relative content score 828, the average differential 830, or a combination thereof. For example, the preference indication module 818 can decrease the relative characteristic score 826 of a panoramic image of a farm if the farm depicted in the panoramic image has not been sold for an extended period of time.

The preference indication module 818 can also calculate a preference indication change 836 as a result of new content being added to the real property postings 210. The preference indication change 836 is a change in the interest indication for a property post due to the addition of new property. For example, the preference indication change 836 can be a change in the total preference score 822 for the real property postings 210 as a result of adding a new instance of the real property content 220.

The preference indication change 836 can include a view indicator change 838, a like indicator change 840, or a combination thereof. The view indicator change 838 is a change in the number of the view indicators 230 received as a result of new images, videos, or other multimedia content being added. The like indicator change 840 is a change in the number of the like indicators 232 received as a result of new images, videos, or other multimedia content being added.

The preference indication module 818 can calculate the preference indication change 836 as an absolute change, a percentage change, a rate of change, a rate of change over time, or a combination thereof. The preference indication module 818 can calculate the preference indication change 836 based on a previous instance of the total preference score 822 before the addition of the new content or based on a baseline value.

For example, the preference indication module 818 can calculate the preference indication change 836 for a posting of a house for sale after the owner of the house adds a new picture of the house to the posting. As an additional example, the preference indication module 818 can calculate the preference indication change 836 for a posting of an apartment for rent after the landlord of the apartment adds a new video of the interior of the apartment to the posting.

The preference indication module 818 can associate the preference indication change 836 with the particular instance of the real property content 220 causing the change. For example, the preference indication module 818 can associate the preference indication change 836 with an image, a video, or a multimedia content added to one of the real property postings.

The preference indication module 818 can calculate the total preference score 822, the preference indication change 836, or a combination thereof based on the filtered session 810, the preference record 812, the filter label 814, the filter information 816, or a combination thereof. For example, the preference indication module 818 can calculate the total indicator score 824 based on the preference indication inputs 228 received in one instance of the filtered session 810.

Also, for example, the preference indication module 818 can calculate the total preference score 822 for all of the preference indication inputs 228 received after the price filter 256 of “under $200,000” is received. As yet another example, the preference indication module 818 can calculate the total preference score 822 for all of the preference indication inputs 228 received after the keyword filter 264 of “blue house” is received.

The preference indication module 818 can also generate an interest history 842 related to the user 240's activities on the electronic system 100. The interest history 842 is a record or log of the interest indications received from a particular user. For example, the interest history 842 can be a history or log of the preference indication inputs 228 received from the user 240.

The preference indication module 818 can generate the interest history 842 by applying a label, a flag, a tag, an identifier, a classifier, or a combination thereof associated with the user 240 to the preference indication inputs 228. The preference indication module 818 can also generate the interest history 842 based on the filtered session 810, the preference record 812, the filter label 814, the filter information 816, or a combination thereof. The interest history 842 can include information concerning the property filter 254, the preference indication inputs 228, or a combination thereof associated with the user 240.

The first control unit 712 can execute the first software 726, the second control unit 734 can execute the second software 742, or a combination thereof to generate the indicator set 820 and the interest history 842, calculate the total preference score 822 and the preference indication change 836, or a combination thereof. In addition, the filter module 808 can store the indicator set 820, the total preference score 822, the preference indication change 836, the interest history 842, or a combination thereof in the first storage unit 714, the second storage unit 748, or a combination thereof.

The preference indication module 818 can communicate or receive the indicator set 820, the total preference score 822, the preference indication change 836, the interest history 842, or a combination thereof between devices through the first communication unit 716, the second communication unit 736, or a combination thereof

After applying and analyzing the property filter 254, the control flow can pass from the preference indication module 818 to the preference maximization module 844. The control flow can pass by having the indicator set 820, the total preference score 822, the preference indication change 836, the interest history 842, or a combination thereof as an output from the preference indication module 818 to an input of the preference maximization module 844.

The preference maximization module 844 is for generating the preference maximization profile 846 for one of the real property postings 210. For example, the preference maximization module 844 can generate the preference maximization profile 846 for the second real property post 214. The preference maximization module 844 can generate the preference maximization profile 846 by determining an analogous property 848.

The analogous property 848 is a property with similar attributes or characteristics as another property. For example, the analogous property 848 can be associated with a property post or content. As a more specific example, the analogous property 848 can be the real property asset 216 indicated in one of the real property postings 210 or the real property asset 216 depicted in the real property content 220.

The preference maximization module 844 can determine the analogous property 848 by determining overlapping characteristics 850 between multiple instances of the real property asset 216 indicated the real property postings 210. The overlapping characteristics 850 are shared instances of the property characteristic 244. For example, one of the real property postings 210 can involve an under $200,000 condominium for sale and another one of the real property postings 210 can involve an under $200,000 home for sale. The former posting and the latter posting can have two of the overlapping characteristics 850 in common with respect to the transaction type 250 and the price 246.

One instance of the real property asset 216 can be considered the analogous property 848 of another instance of the real property asset 216 if enough of the overlapping characteristics 850 exists. The preference maximization module 844 can consider one instance of the real property asset 216 the analogous property 848 of another instance of the real property asset 216 if the overlapping characteristics 850 between the two properties exceed a semblance threshold 852.

The semblance threshold 852 is a numerical value for determining the analogous property 848 based on the amount of the overlapping characteristics 850 shared between two or more properties. For example, the semblance threshold 852 can be four instances of the overlapping characteristics 850. As a more specific example, the semblance threshold 852 can be three characteristics in common such as the price 246, the property type 248, or the transaction type 250.

As a more specific example, the preference maximization module 844 can determine the real property asset 216 indicated in the first real property post 212 as the analogous property 848 of the real property asset 216 indicated in the second real property post 214 if the two instances of the real property asset 216 share enough of the overlapping characteristics 850 to exceed the semblance threshold 852. The preference maximization module 844 can also apply the weighting mechanism 832 in determining the analogous property 848. For example, the preference maximization module 844 can put more weight on the property type 248 than the price 246 when determining the semblance threshold 852, the overlapping characteristics 850, or a combination thereof.

After the preference maximization module 844 has determined the analogous property 848, the preference maximization module 844 can retrieve the real property content 220 associated with the analogous property 848 from the property database 804. For example, if the real property asset 216 indicated in the first real property post 212 is determined to be the analogous property 848 of the real property asset 216 of the second real property post 214 then the preference maximization module 844 can retrieve the real property content associated with the first real property post 212.

The preference maximization module 844 can then generate the preference maximization profile 846 based on the real property content 220 with the highest instances of the total preference score 822, the preference indication change 836, or a combination thereof. Continuing with the example above, if first real property post 212 is determined to be the analogous property 848 of the real property asset 216 of the second real property post 214, then the preference maximization module 844 can retrieve the real property content 220 associated with the first real property post 212 with the highest instances of the total indicator score 824, the relative characteristic score 826, the relative content score 828, the average differential 830, the view indicator change 838, the like indicator change 840, or a combination thereof

As a more specific example, the first real property post 212 can involve a Victorian-style house for sale for under $300,000 and the second real property post 214 can involve a Tudor-style house for sale for under $300,000. The preference maximization module 844 can generate the preference maximization profile 846 for the Tudor-style house of the second real property post 214 by including images, videos, or other multimedia content of the Victorian-style house with the most views or likes.

The preference maximization module 844 can generate the preference maximization profile 846 as a data cluster, data group, data set, or a combination thereof. The preference maximization module 844 can implement the preference maximization profile 846 as part of a dataset, a relational database, a key value store, or a combination thereof. The preference maximization module 844 can also store the preference maximization profile in the property database 804.

The preference maximization module 844 can be part of the first software 726, the second software 742, or a combination thereof. The first control unit 712 can execute the first software 726, the second control unit 734 can execute the second software 742, or a combination thereof to generate the preference maximization profile 846. In addition, the preference maximization module 844 can store the preference maximization profile 846 in the first storage unit 714, the second storage unit 748, or a combination thereof.

The preference maximization module 844 can communicate or receive the preference maximization profile 846 between devices through the first communication unit 716, the second communication unit 736, or a combination thereof

After generating the preference maximization profile 846, the control flow can pass from the preference maximization module 844 to the proposed content module 854. The control flow can pass by having the preference maximization profile 846 as an output from the preference maximization module 844 to an input of the proposed content module 854.

The proposed content module 854 is for generating the proposed property content 504. The proposed content module 854 can generate the proposed property content 504 based on the preference maximization profile 846. The proposed content module 854 can generate the proposed property content 504 based on the real property content 220 included as part of the preference maximization profile 846.

The proposed property content 504 can include the representative content 226, the real property content 220 associated with one or more of the real property postings 210, or a combination thereof. The proposed content module 854 can include such content as part of the proposed property content 504 because the content received a high instance of the total preference score 822, the total indicator score 824, the relative characteristic score 826, the relative content score 828, the average differential 830, or a combination thereof

A high instance of such a score can refer to the total preference score 822, the total indicator score 824, the relative characteristic score 826, the relative content score 828, the average differential 830, or a combination thereof exceeding an average, median, or baseline score by a predetermined threshold provided by the user 240, the electronic system 100, or a combination thereof. The predetermined threshold can be a number value, a range, or a combination thereof.

The proposed property content 504 can include a proposed property plan 506, a proposed interior content 508, a proposed exterior content 510, or a combination thereof. The proposed property plan 506 is a proposed content based on the property plan 404 associated with one of the real property postings 210. For example, the proposed property plan 506 can include a floor plan, a blueprint, an architectural plan, or a combination thereof

The proposed interior content 508 is proposed content depicting an interior of a property. For example, the proposed interior content 508 can include an image of a living room, a video of a kitchen, an animation of a stairwell, or a combination thereof. The proposed exterior content 510 is proposed content depicting an exterior of a property. For example, the proposed exterior content 510 can include an panoramic video of a backyard, an image of a tree on a property, or a combination thereof.

The proposed property content 504 can also include a rendered content 856. The rendered content 856 is a property content rendered by the electronic system 100. For example, the proposed content module 854 can generate the rendered content 856 by generating a sketch, an outline, a pixilation, or a combination thereof of the real property content 220. As an additional example, the proposed content module 854 can also generate the rendered content 856 by applying a color filter, a grayscale, a drop shadow, a tint effect to the real property content 220.

The rendered content 856 can also include an amalgamated content 858. The amalgamated content 858 is a property content including multiple instances of the real property content 220. For example the amalgamated content 858 can include a panoramic image of a backyards stitched or combined from several different images. As an additional example, the amalgamated content can include a video of an interior of a house composed of smaller video segments of other house interiors. The proposed content module 854 can generate the rendered content using a layering technique, an overlay technique, a stitching technique , cropping technique, or a combination thereof.

The proposed property content 504 can also generate the proposed property content 504 based on the filtered session 810, the preference record 812, the filter label 814, the filter information 816, or a combination thereof. For example, the proposed content module 854 can classify the proposed property content 504 using the filter label 814. The proposed content module 854 can also generate the proposed property content 504 based on its appeal for an instance of the property filter 254. As a more specific example, the proposed content module 854 can generate a panoramic compilation image of a backyard as the proposed property content 504 because it appeals the most to users who apply the keyword filter 264 of “backyard.”

The proposed content module 854 can display the proposed property content 504 to the user 240 through the user dashboard 502 or display the proposed property content 504 directly on the presentation graphic 204. For example, the proposed content module 854 can use the proposed property content 504 as the representative content 226 for one of the real property postings.

The proposed content module 854 can be part of the first software 726, the second software 742, or a combination thereof. The first control unit 712 can execute the first software 726, the second control unit 734 can execute the second software 742, or a combination thereof to generate the proposed property content 504, the rendered content 856, the amalgamated content 858, or a combination thereof. In addition, the proposed content module 854 can store the proposed property content 504, the rendered content 856, the amalgamated content 858, or a combination thereof in the first storage unit 714, the second storage unit 748, or a combination thereof.

The proposed content module 854 can communicate or receive the proposed property content 504, the rendered content 856, the amalgamated content 858, or a combination thereof between devices through the first communication unit 716, the second communication unit 736, or a combination thereof.

After applying and analyzing the property filter 254, the control flow can pass from the proposed content module 854 to the comparison module 860. The control flow can pass by having the proposed property content 504 as an output from the proposed content module 854 to an input of the comparison module 860.

The comparison module 860 is for comparing the real property content 220 received in response to the proposed property content 504 and generating the revised proposed content 514. The comparison module 860 can compare the submitted content 512 with the proposed property content 504 based on a content matching mechanism 862.

The content matching mechanism 862 can include a content matching algorithm, a photographic recognition technique, a photographic comparison technique, an audio comparison technique, a video frame comparison technique, or a combination thereof. As a more specific example, the content matching mechanism 862 can include an edge-matching method, a gradient matching method, a pattern-matching method, or a combination thereof.

The comparison module 860 can generate a content comparison score 864 based on the comparison between the submitted content 512 and the proposed property content 504. The content comparison score 864 is a numerical representation of the similarity between two property content. For example, the content comparison score 864 can be a percentage score indicating the similarity of one image of a house with another image of a house. As an additional example, the content comparison score 864 can be an absolute score indicating the similarity of one video of an office space with another video of an office space.

The comparison module 860 can generate the content comparison score 864 based on a comparison of the accommodation offering 252, the vantage point 406, the content setting 402, or a combination thereof of the submitted content 512 with the proposed property content 504. For example, the comparison module 860 can increment the content comparison score 864 when the accommodation offering 252 shown in the submitted content 512 is the same as the accommodation offering 252 shown in the proposed property content 504. As an additional example, the comparison module 860 can decrement the content comparison score 864 when the content setting 402 of the submitted content 512 is different from the content setting 402 shown in the proposed property content 504.

The comparison module 860 can also generate a revised proposed content 514 based on the content comparison score 864. For example, the comparison module 860 can generate the revised proposed content 514 when the content comparison score 864 does not exceed a predetermined threshold provided by the user 240, the electronic system 100, or a combination thereof. The revised proposed content 514 can be a new instance of the proposed property content 504.

The comparison module 860 can generate the revised proposed content 514 by using real property content 220 from the preference maximization profile 846. The revised proposed content 514 can include the rendered content 856, the amalgamated content 858, or a combination thereof. The electronic system 100 can establish an iterative process where the comparison module 860 continues to generate the revised proposed content 514 until the submitted content 512 resembles the proposed property content 504.

The comparison module 860 can also interact with the preference maximization module 844 to include the revised proposed content 514 as part of the preference maximization profile 846. In this sense, the control flow can pass from the comparison module 860 back to the preference maximization module 844.

The comparison module 860 can be part of the first software 726, the second software 742, or a combination thereof. The first control unit 712 can execute the first software 726, the second control unit 734 can execute the second software 742, or a combination thereof to calculate the content comparison score 864 and generate the revised proposed content 514. In addition, the comparison module 860 can store content comparison score 864, the revised proposed content 514, or a combination thereof in the first storage unit 714, the second storage unit 748, or a combination thereof.

The preference indication module 818 can communicate or receive the content comparison score 864, the revised proposed content 514, or a combination thereof between devices through the first communication unit 716, the second communication unit 736, or a combination thereof.

After calculating the content comparison score 864 and generating the revised proposed content 514, the control flow can pass from the comparison module 860 to the recommendation module 866. The control flow can pass by having the content comparison score 864, the revised proposed content 514, or a combination thereof as an output from the comparison module 860 to an input of the recommendation module 866.

The recommendation module 866 is for generating a notification 868, the recommendation 608, or a combination thereof to various users of the electronic system 100. The recommendation module 866 can generate the notification 868, the recommendation 608, or a combination thereof to the user 240, the followers 604 of the user 240, the social network contacts 606 of the user 240, or a combination thereof. In the case where the electronic system 100 is a real-property focused social network, the followers 604 of the user can also be the social network contacts 606 of the user 240.

The notification 868 is an alert or update with information concerning the activities of a user on the electronic system 100. For example, the notification 868 can include information on the view indicators 230, the like indicators 232, or a combination thereof of the user 240. As a more specific example, the notification 868 can include information on the real property postings 210 viewed by the user 240 in the last week.

As an additional example, the recommendation module 866 can generate the notification 868 based on the interest history 842 of the user 240, the followers 604, or a combination thereof. The recommendation module 866 can receive a request through the first display interface 730, the first communication interface 728, the second display interface 740, the second communication interface 750, or a combination thereof of a user's desire to receive the notification 868 concerning another user on the electronic system. For example, one of the social network contacts 606 of the user 240 can choose to receive alerts or updates concerning the user 240's activities on the electronic system 100 by clicking on a “Follow” button.

The recommendation 608 can include one of the real property postings 210, the real property content 220 associated with one of the real property postings 210, or a combination thereof. For example, the recommendation 608 can include the first real property post 212, the second real property post 214, the first property content 222, the second property content 224, or a combination thereof.

The recommendation module 866 can generate the notification 868, the recommendation 608, or a combination thereof to the user 240, the followers 604 of the user 240, or the social network contacts 606 of the user 240 based on a preference match 870. The preference match 870 is a score signifying a similarity in the taste or interest of one user with another. For example, the recommendation module 866 can calculate the preference match 870 based on the interest history 842 of the user 240 compared to the interest history 842 of one of the followers 604 of the user 240, another user of the electronic system 100, or a combination thereof. The recommendation module 866 can use a machine learning mechanism, a pattern-recognition mechanism, or a combination thereof to calculate the preference match 870.

In addition, the recommendation module 866 can include as part of the recommendation 608 one of the real property postings 210 not viewed or liked by any of: the user 240, the followers 604, the social network contacts 606, or a combination thereof. For example, the recommendation 608 can include a post of a two-bedroom condominium for sale not viewed or liked by the user 240. The recommendation module 866 can recommend the post of the two-bedroom condominium based on the preference match 870 of the interest history 842 of other users who have viewed the post with the interest history 842 of the user 240.

The recommendation module 866 can be part of the first software 726, the second software 742, or a combination thereof. The first control unit 712 can execute the first software 726, the second control unit 734 can execute the second software 742, or a combination thereof to generate the recommendation 608, the notification 868, the preference match 870, or a combination thereof. In addition, the recommendation module 866 can store the recommendation 608, the notification 868, the preference match 870, or a combination thereof in the first storage unit 714, the second storage unit 746, or a combination thereof.

The recommendation module 866 can also interact with the presentation module 802 to modify the ranking arrangement 268 based on the recommendation 608, the notification 868, the preference match 870, or a combination thereof. For example, the presentation module 802 can display a portion of the recommendation 608 on the presentation graphic 204 of one of the followers 604 of the user 240.

As a more specific example, one of the followers 604 of the user 240 can be viewing the map graphic 208 on his or her own device. At the same time, the user 240 can be viewing the grid graphic 206 on the user 240's device. When the user 240 clicks a “Like” button on an image of a house for sale, the presentation module 802 can display the image of the house on the map graphic 208 of one of the followers 604 accompanied by the notification 868.

Continuing with the example above, the presentation module 802 can also modify the ranking arrangement 268 of the grid graphic 206 of one of the followers 604 based on the user 240's actions. The presentation module 802 can display the image of the house as the representative content 226 at the top of the grid graphic 206 of one of the followers 604. In this scenario, the control flow can pass back to the presentation module 802 from the recommendation module 866.

It has been discovered that generating the proposed property content 504 based on the preference maximization profile 846, the preference indication inputs 228, the real property content 220, or a combination thereof provides for more relevant real property content displayed on the presentation graphic 204. The electronic system 100 can solicit more page views or likes for the real property postings 210 displayed on the presentation graphic 204 by encouraging users, such as sellers or brokers of real property, to submit content that appeal to other users on the electronic system 100.

It has further been discovered that generating the proposed property content 504 based on the preference maximization profile 846 provides for faster and more effective generation of the proposed property content 504. The electronic system 100 can apply the same instance of the preference maximization profile 846 to different instances of the real property postings 210 and can modify the preference maximization profile 846 as new instances of the real property content 220 become available. The electronic system 100 can generate the proposed property content 504 more efficiently using the preference maximization profile 846 rather than generating the content from scratch.

It has been discovered that applying the transaction adjustment 834 to the total preference score 822 used to generate the preference maximization profile 846 provides for a greater user engagement with the electronic system 100. By doing so, the electronic system 100 can ensure that the most effective instances of the real property content 220 are the ones that result in a completed instance of the real property transaction 218. As a result, the electronic system 100 takes such real world consideration into account when generating the proposed property content 504 using the preference maximization profile 846.

It has been discovered that generating the preference maximization profile 846 or the proposed property content 504 based on the filtered session 810, the preference record 812, or a combination thereof provides for an improved user experience. Since most electronic or online property searches begin with a filter request, the electronic system 100 can organize or sort the preference indication inputs 228 received based on the property filter 254. As a result, the user 240 can see property content and receive property recommendations that are more tailored to filtered searches.

It has been discovered that applying the weighting mechanism to the total preference score 822 provides for more relevant property content that reflect the true interests of the users on the electronic system 100. By favoring certain of the preference indication inputs 228 over others, the electronic system 100 can ensure that the proposed property content 504 generated as a result of the total preference score 822 serves as an accurate indicator of the types of content that attract the most attention from users on the electronic system 100.

It has been discovered that generating the proposed property content 504 based on the vantage point 406, the content setting 402, or a combination thereof of the real property content 220 provides for more fine-tuned content that appeal to users of the electronic system 100. Since the vantage point 406 or the content setting 402 of an image or video depicting the property or a property feature often has a big effect on a user's perception of the property, the electronic system 100 can fine-tune the proposed property content 504 to capture such nuances in the real property content 220.

The modules in FIG. 8 can be implemented by hardware acceleration units (not shown) in the control units. The modules in FIG. 8 can also be implemented by separate hardware units (not shown) outside the control units but with the first device 102 or the second device 106.

The modules described in this application can be implemented as instructions stored on a non-transitory computer readable medium to be executed by the first control unit 712, the second control unit 734, or a combination thereof. The non-transitory computer medium can include the first storage unit 714, the second storage unit 746, or a combination thereof. The non-transitory computer readable medium can include non-volatile memory, such as a hard disk drive, non-volatile random access memory (NVRAM), solid-state storage device (SSD), compact disk (CD), digital video disk (DVD), or universal serial bus (USB) flash memory devices. The non-transitory computer readable medium can be integrated as a part of the electronic system 100 or installed as a removable portion of the electronic system 100.

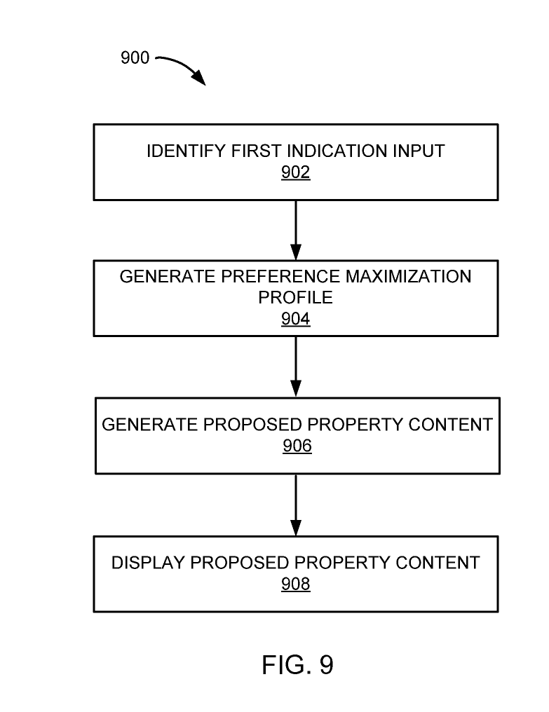

Referring now to FIG. 9, therein is shown a flow chart of a method 900 of operation of the electronic system 100 in a further embodiment of the present invention. The method 900 includes: identifying, with a control unit 712 the first indication input 234 associated with the first real property post 212 in a block 902; generating the preference maximization profile 846 of the second real property post 214 based on the first indication input 234 in a block 904; generating the proposed property content 504 based on the first indication input 234, the preference maximization profile 846, the second real property post 214, or a combination thereof for procuring a second indication input 236 associated with the second real property post 214 in a block 906; and displaying, with a display unit 730 coupled to the control unit 712, the proposed property content 504 in a block 908.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of the present invention is that it valuably supports and services the historical trend of reducing costs, simplifying systems, and increasing performance. These and other valuable aspects of the present invention consequently further the state of the technology to at least the next level.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. An electronic system comprising:
a control unit, configured to:
identify a first indication input associated with a first real property post;
generate a preference maximization profile of a second real property post based on the first indication input;
generate a proposed property content based on the first indication input, the preference maximization profile, the second real property post, or a combination thereof for procuring a second indication input associated with the second real property post; and
a display unit, coupled to the control unit, configured to:
display the proposed property content.

2. The system as claimed in claim 1 wherein the control unit is configured to:
identify a first property content associated with the first real property post;
determine a total preference score for the first property content;
calculate a preference indication change for the first property content; and
generate the preference maximization profile based on the total preference score, the preference indication change, or a combination thereof

3. The system as claimed in claim 1 wherein the control unit is configured to:
determine a vantage point of a first property content associated with the first real property post; and
generate the proposed property content based on the vantage point of the first property content.

4. The system as claimed in claim 1 wherein the control unit is configured to:
identify a price filter prior to receiving the first indication input; and
generate the preference maximization profile based on the price filter, the first indication input, or a combination thereof

5. The system as claimed in claim 1 wherein the control unit is configured to:
identify a second property content for emulating the proposed property content;
calculate a content comparison score of the second property content against the proposed property content; and
generate a revised proposed content based on the content comparison score, the second property content, the proposed property content, or a combination thereof.

6. The system as claimed in claim 1 wherein the control unit is configured to:
determine a content setting of a first property content associated with the first real property post; and
generate the proposed property content based on the content setting of the first property content.

7. The system as claimed in claim 1 wherein the control unit is configured to:
identify a keyword filter prior to receiving the first indication input; and
generate the preference maximization profile based on the keyword filter, the first indication input, or a combination thereof.

8. The system as claimed in claim 1 wherein the control unit is configured to:
identify a user associated with the first indication input, the second indication input, or a combination thereof; and
generate a recommendation for the user concerning the second real property post based on the first indication input, the second indication input, or a combination thereof.

9. The system as claimed in claim 1 wherein the control unit is configured to:
identify a user associated with the first indication input, the second indication input, or a combination thereof; and
generate a recommendation for a social network contact of the user concerning the second real property post based on the first indication input, the second indication input, or a combination thereof.

10. The system as claimed in claim 1 wherein the control unit is configured to:
generate a presentation graphic for displaying the first real property post, the second real property post, or a combination thereof; and
determine a ranking arrangement of the presentation graphic based on the first indication input, the second indication input, or a combination thereof.

11. A method of operation of an electronic system comprising:
identifying, with a control unit, a first indication input associated with a first real property post;
generating a preference maximization profile of a second real property post based on the first indication input;
generating a proposed property content based on the first indication input, the preference maximization profile, the second real property post, or a combination thereof for procuring a second indication input associated with the second real property post; and
displaying, with a display unit, the proposed property content.

12. The method as claimed in claim 11 wherein generating the preference maximization profile includes:
identifying a first property content associated with the first real property post;
determining a total preference score for the first property content;
calculating a preference indication change for the first property content; and
generating the preference maximization profile based on the total preference score, the preference indication change, or a combination thereof.

13. The method as claimed in claim 11 wherein generating the proposed property content includes:
determining a vantage point of a first property content associated with the first real property post; and
generating the proposed property content based on the vantage point of the first property content.

14. The method as claimed in claim 11 further comprising:
identifying a price filter prior to receiving the first indication input; and
generating the preference maximization profile based on the price filter, the first indication input, or a combination thereof.

15. The method as claimed in claim 11 further comprising:
identifying a second property content for emulating the proposed property content;
calculating a content comparison score of the second property content against the proposed property content;
generating a revised proposed content based on the content comparison score, the second property content, the proposed property content, or a combination thereof

16. A non-transitory computer readable medium, including instructions for execution, comprising:
identifying a first indication input associated with a first real property post;
generating a preference maximization profile of a second real property post based on the first indication input;
generating a proposed property content based on the first indication input, the preference maximization profile, the second real property post, or a combination thereof for procuring a second indication input associated with the second real property post; and
displaying the proposed property content.

17. The non-transitory computer readable medium as claimed in claim 16 wherein generating the preference maximization profile includes:
identifying a first property content associated with the first real property post;
determining a total preference score for the first property content;
calculating a preference indication change for the first real property post; and
generating the preference maximization profile based on the total preference score, the preference indication change, or a combination thereof.

18. The non-transitory computer readable medium as claimed in claim 16 wherein generating the proposed property content includes:
determining a vantage point of a first property content associated with the first real property post; and
generating the proposed property content based on the vantage point of the first property content.

19. The non-transitory computer readable medium as claimed in claim 16 further comprising:
identifying a price filter prior to receiving the first indication input; and
generating the preference maximization profile based on the price filter, the first indication input, or a combination thereof

20. The non-transitory computer readable medium as claimed in claim 16 further comprising:
identifying a second property content for emulating the proposed property content;
calculating a content comparison score of the second property content against the proposed property content;
generating a revised proposed content based on the content comparison score, the second property content, the proposed property content, or a combination thereof
